(19) United States
(12) Patent Application Publication
(10) Pub. No.: US 2009/0147421 A1
(43) Pub. Date: Jun. 11, 2009

(54) CURRENT-LIMITING CIRCUIT WITH AT LEAST TWO VOLTAGE TAPS

(75) Inventor: Dieter KLAUSGRETE, Goettingen (DE)

Correspondence Address: SUGHRUE MION, PLLC, 2100 PENNSYLVANIA AVENUE, N.W., SUITE 800, WASHINGTON, DC, 20037, US

(73) Assignee: Sartorius AG, Goettingen (DE)

(21) Appl. No.: 12/329,220

(22) Filed: Dec. 5, 2008

(30) Foreign Application Priority Data
Dec. 5, 2007 (DE) 10 2007 058 920.6

(51) Int. Cl. H02H 9/02

(52) U.S. Cl. 361/57; 361/93.7

(57) ABSTRACT

A current-limiting circuit, which limits an electrical current from a voltage source to a consumer to a predetermined maximum current. At least one measuring resistor (110) is connected in a current lead (14) between a circuit input (12) and a circuit output (16). At least two current control elements (100, 100′; 106, 106′) are connected in series to the at least one measuring resistor (110), each of these elements having a voltage-dependent control unit (100, 100′; 116, 116′) allocated to it. Each control unit (100, 100′; 116, 116′) is connected to a voltage tap (112, 114; 112′, 114′) that is allocated to it and taps a voltage drop across the one measuring resistor (110), such that the plurality of voltage taps (112, 114; 112′ 114′), which are allocated respectively to the various control units (100, 100′; 106, 106′), tap the voltage drop across the one measuring resistor (110).

The following disclosure is based on German Patent Application No. DE 10 2007 058 920.6, filed on Dec. 5, 2007, which is incorporated into this application by reference.

### FIELD AND BACKGROUND OF THE INVENTION

The invention relates to a current-limiting circuit, which limits an electrical current from a voltage source to a consumer to a predetermined maximum current. Such a circuit includes one or more measuring resistors connected into a current lead between a circuit input and a circuit output, and one or more current control elements which are connected in series to the respective measuring resistors. Each of the current control elements has a voltage-dependent control unit allocated to it, wherein each control unit is connected to a respective voltage tap, which taps a voltage drop across the respective measuring resistor.

Current-limiting circuits of this type are known in particular from the field of power supply for consumers in an explosion-prone environment. They fulfill an important criterion for explosion protection. The purpose of a current-limiting circuit is to prevent an electrical current above the allowed maximum current from being supplied into the explosion-prone environment in the event of a short circuit or other malfunction of the consumer. This prevents excessive heating of individual components and/or sparking in the hazardous environment. Due to the importance of efficient explosion protection, two independent current-limiting circuits connected one after the other are typically used.

FIG. 2 schematically shows a typical current-limiting circuit 20 for the power supply of consumers in an explosion-prone environment. The current to be fed to the consumer is introduced at the circuit input 22 by an unillustrated voltage source and conducted by the current lead 24 to the circuit output 26, which is connected to the consumer (also not illustrated). The current passes through two independent current-limiting subcircuits 200 and 200′. In FIG. 2, the current lead 24 is indicated by a dashed line within the boxes symbolizing the current-limiting subcircuits 200 and 200′ in order to symbolize the current-limiting function. Those skilled in the art can implement the current-limiting subcircuits in any of a variety of presently known embodiments or in a manner as yet unknown. One measuring resistor 210, 210′, through which the current through the current lead 24 also flows, is allocated respectively to each current-limiting subcircuit 200, 200′. At each of the measuring resistors 210, 210′, this produces a voltage drop, which is tapped by a respective voltage tap 212/214, 212′/214′ and applied to a voltage input of the respective current-limiting subcircuit 200, 200′. Each of the current-limiting subcircuits 200, 200′ operates in dependency upon the measured voltage drop through the respective measuring resistor 210, 210′ allocated to it.

If the current through the current lead 24 exceeds a predefined critical value, the voltage drop through each of the measuring resistors 210, 210′ will independently also exceed a corresponding critical voltage value that activates the function of the respectively allocated current-limiting subcircuit 200, 200′.

For structural reasons associated in particular with the design-related minimum reference voltage of shunt regulators, which are often used in typical circuit-limiting circuits, the typically used resistance values of measuring resistors are not below 10 ohms. For typical current intensities of approximately 100 milliamperes, this means that a voltage drop of approximately 2 volts is generated by the safety precaution of the current-limiting circuit alone. This is a comparatively large value in view of the generally common request prevalent in the electronics industry for as large a reduction as possible of all voltages that occur.

### OBJECT OF THE INVENTION

One object of the present invention is to further develop generic circuit-limiting circuits of this type such that voltage sources with lower output voltages can be used without impairing safety.

### SUMMARY OF THE INVENTION

According to one inventive arrangement, a plurality of voltage taps, which are allocated to various control units, tap the voltage drop across one and the same measuring resistor.

The safety redundancy required in explosion protection relies solely on the independence of the current-limiting subcircuits and in the detection of the critical current value. At which location in the circuit the critical current is detected is irrelevant to the safety aspects. According to one aspect, the invention therefore provides that an effect produced by the current flow at one location in the circuit, namely the voltage drop across a measuring resistor, is measured twice and independently of one another, and is evaluated in independent current-limiting subcircuits. If namely a defect appears in either of the independent voltage taps or independent current-limiting subcircuits, e.g., due to line interruption, the undamaged circuit and the undamaged voltage tap will satisfy the required task as before. But if the defect appears in the mutually used part, i.e., in the area of the current lead between the voltage taps or in the measuring resistor itself, the current is interrupted completely and an overcurrent in the explosion-prone room is likewise excluded.

One advantage of the proposed circuit is in the significant reduction, in particular the halving, of the voltage drop that is introduced into the line between source and consumer for safety reasons alone, in comparison to redundant circuits according to the state of the art.

For the measuring resistor, it is preferable to take care to choose a resistor type that becomes reliably high-ohmic in case of a defect. To this end, wire-wound or metal-film resistors present themselves in particular. Carbon or metal-layer resistors should preferably be avoided.

At least one of the current-limiting subcircuits is preferably designed such that at least one current control element is configured as a transistor that is coupled into the current lead with its collector-base junction in series to the measuring resistor. Preferably, the base of the transistor is connected to the current lead by means of a series resistor, and the allocated control unit is configured as a shunt regulator whose cathode is connected to the base of the transistor and whose anode and reference input are connected to the voltage tap through the measuring resistor. Certain current-limiting subcircuits, individually or connected one after another in series, are known per se in the art.

It is particularly preferred to provide, in parallel to the transistor, an additional, preferably high-ohmic current path including a component that is connected reverse-biased and that has a diode characteristic and an auxiliary measuring resistor that is integrated in the voltage tap. An auxiliary series resistor is preferably connected upstream to the component having a diode characteristic, this component preferably being configured as a Z-diode or as another shunt regulator having a reference input back-coupled in particular to its cathode. One basic idea of such an extension of known current-limiting subcircuits is to limit the power consumption of the transistor in case of damage. Consumers in an explosion-prone environment are typically operated only with currents that are approximately ⅔ of the allowable maximum current. If a short circuit occurs in a consumer, for example, the transistors of the current-limiting subcircuits of known type must each conduct the maximum current, resulting in high power consumption and possibly a corresponding heating that will cause damage.

Previously, designers managed with an oversized dimensioning of the transistors, but this is a disadvantage in view of the component costs, the printed-circuit-board (PCB) space and the mountability of the PCB. But the further development of the present invention described above, however, provides for an additional current path, which bypasses the transistor and is activated only when the voltage across the component having the diode characteristic reaches a critical value. This component is connected in parallel to the transistor to be unloaded, and the critical value preferably is reached when the current flow is in the range of the allowable maximum current. The component having the diode characteristic then connects through and a current flows through the auxiliary measuring resistor, which is integrated in the voltage tap via the actual measuring resistor. From the “viewpoint” of the allocated current-limiting subcircuit, the voltage drop across the auxiliary measuring resistor adds to the voltage drop across the actual measuring resistor, so that the current-limiting subcircuit drives its transistor to a reduced current that is below the maximum current. If the current through the current lead again drops within the range of normal operation, e.g., after a defect in the consumer has been corrected, the component having the diode characteristic again inhibits the additional current path, so that the auxiliary measuring resistor again becomes “invisible” to the current-limiting circuit and the current intensity supplied to the consumer can again fluctuate between zero and the allowable maximum current. Advantages of this further development of the invention over the known transistor protective measures using thermosensors include a very short reaction time and a simple reversibility after correction of the defect.

### BRIEF DESCRIPTION OF THE DRAWINGS

These and further characteristics and advantages are described below in greater detail with reference to exemplary embodiments and the drawings.

The drawings show:

FIG. 1 a schematic representation of a current-limiting circuit according to the invention;

FIG. 2 a schematic representation of a representative, non-inventive current-limiting circuit; and

FIG. 3 a detailed representation of a preferred embodiment of a current-limiting circuit according to the invention.

### DETAILED DESCRIPTION OF THE PREFERRED EMBODIMENTS

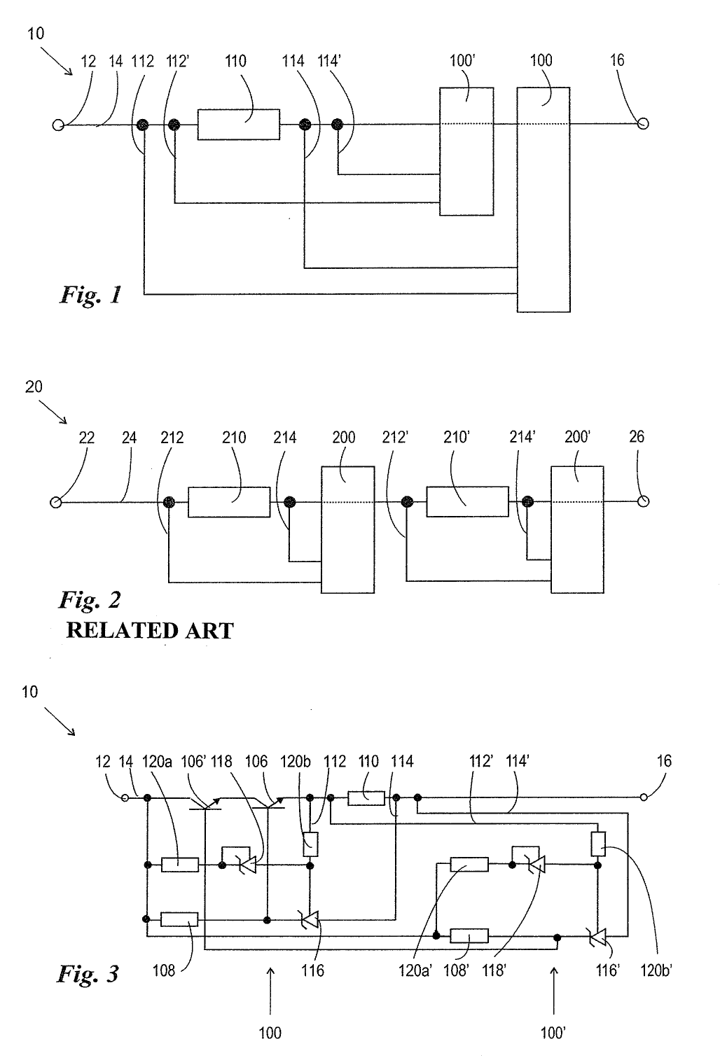

FIG. 1 shows a schematic representation of a current-limiting circuit 10 according to the invention. The purpose of the circuit is to limit to a predefined maximum current a current flow through a current lead 14 between a circuit input 12 that can be connected to a current source and a circuit output 16 that can be connected to a consumer. Such current-limiting circuits are sought, e.g., for use in situations requiring explosion-protection. During the normal operation of the consumer, the current can fluctuate within the allowable limits depending on the requirements of the consumer. It passes through two current-limiting subcircuits 100 and 100′, which are integrated into the current lead 14 one after the other in series. In the boxes that represent the current-limiting subcircuits 100, 100′ in FIG. 1, the current lead 14 is represented as dashes to symbolize the effect of current limitation. Those skilled in the art can implement the current-limiting subcircuits 100 and 100′ per se in any of a variety of embodiments presently known or newly developed.

A voltage tap across the mutual measuring resistor 110 is allocated to each of the current-limiting subcircuits 100, 100′. The voltage tap of the current-limiting subcircuit 100 consists of the tap branches 112 and 114, and the voltage tap of the current-limiting circuit 100′consists of the branches 112′ and 114′. As would be apparent to a person skilled in the art through simple physical considerations, both voltage taps 112/114, 112′/114′ measure essentially the same voltage drop across the measuring resistor 110 and thus conduct essentially the same input value to each of the current-limiting subcircuits 100, 100′. If the current-limiting subcircuits 100, 100′ have an essentially identical design, this results in an essentially identical effect on the current lead 14, so that the requirement for a redundant current limitation in explosion protection is completely satisfied. A defect in the mutual portion of the safety circuit, i.e., in the area of the current lead 14 between the tap branch 112 and the tap branch 114′ in the represented embodiment, is irrelevant to the safety aspects because such a defect would result in a complete interruption of the current flow. When choosing the measuring resistor 110, it is only necessary to take care that the resistor will become high-ohmic when a defect occurs.

As mentioned, such a circuit has the advantage of reducing, in particular halving, the voltage drop additionally introduced for reasons of safety alone in comparison to circuits according to the state of the art, such as those represented by way of example in FIG. 2 and already explained above.

FIG. 3 shows a particularly preferred embodiment of the present invention in which the power consumption of the critical parts of the current-limiting subcircuits 100, 100′ is significantly reduced compared to known subcircuits when a short circuit occurs.

Because of the essentially identical design of the current-limiting subcircuits 100, 100′, their principle and method of operation will be explained below only on the basis of the subcircuit 100. Extrapolation of this explanation to the subcircuit 100′, whose components each have the same reference numerals as those of subcircuit 100 but are marked with “′”, will be apparent to those skilled in the art from the explanation provided.

In normal operation, a current flows through the current lead 14 from the circuit input 12 to the circuit output 16 and thereby passes through the collector-emitter path of the transistor 106 and the measuring resistor 110 connected in series thereto. The base of the transistor 106 is connected to the current lead 14 through a series resistor 108, so that the base current needed for correct control of the transistor in normal operation is delivered. The voltage drop caused by the current flow through the measuring resistor 110 is tapped by a voltage tap, which is formed by the tap branches 112 and 114, and applied to the reference input and the anode of a shunt regulator 116. Shunt regulators are often also called controllable diodes and can be obtained, for example, from Semiconductor Components Industries, LLC under the designation TLV431. Comparable components can also be obtained from other companies under other designations. The cathode of the shunt regulator 116 is connected to the base of the transistor 106. If the current through the measuring resistor 110 increases above and beyond an allowable extent, then the voltage drop tapped across the measuring resistor 110 also increases over a limit value, so that the cathode of the shunt regulator 116 applies a base current to the base of the transistor 106. As a result, the transistor is compelled to reduce the current conducted across the collector-emitter path to the allowable maximum current. The current-limiting circuits can be implemented by those skilled in the art based on the present discussion and the ordinary skill available to them.

For the embodiments represented in FIG. 3, however, an additional current path, which bypasses the transistor 106 and comprises an additional shunt regulator 118, an auxiliary series resistor 120a and an auxiliary measuring resistor 120b, is provided. The latter is integrated in the voltage-tap branch 112. During normal operation, the additional shunt regulator 118 functions as an inhibitor. The auxiliary measuring resistor is “invisible” to the reference input of the first shunt regulator 116 in this state, because the current flowing through it is negligible due to the high impedance of the reference input of the shunt regulator 116. If a short circuit occurs (or more generally, if the current required by the consumer is larger than the set maximum current of the current limit), the reference voltage of the additional shunt regulator 118 will be exceeded when the voltage drop across the transistor 106 rises, so that the additional current path becomes conducting and, in particular, a current flows through the auxiliary measuring resistor 120b. From the “viewpoint” of the reference input of the first shunt regulator 116, this results in an increase of the tapped total resistance, so that its cathode controls the base of the transistor 106 such that the current across the collector-emitter path is reduced below the maximum current. Only after the short circuit has been corrected does the voltage drop across the transistor 106 drop so far that the additional shunt regulator functions as an inhibitor again and the circuit can transition to normal operation.

In this manner, it is ensured that the current required by the consumer can utilize the entire allowed range; yet in the event of a short circuit, the transistor 106 is prevented from continuously being loaded with the maximum current, thereby permitting a smaller design for the transistor 106.

Of course, the embodiments discussed in the detailed description and shown in the figures represent only illustrative embodiments of the present invention. In view of the present disclosure, the person skilled in the art has been given a wide spectrum of variation options. In particular, the invention is not limited to the last discussed, particularly preferred embodiment of the current-limiting circuits. The concrete sequence of the voltage taps across the measuring resistor 110 and the disposal of the current-limiting circuits 100, 100′ on the one side, on the other side, or on both sides of the measuring resistor are also not relevant to the invention. Of course, it is also left up to the person skilled in the art to combine a current-limiting circuit according to the invention with other safety measures.

The above description of specific embodiments has been given by way of example. From the disclosure given, those skilled in the art will not only understand the present invention and its attendant advantages, but will also find apparent various changes and modifications to the embodiments disclosed. The applicant seeks, therefore, to cover all such changes and modifications as fall within the spirit and scope of the invention, as defined by the appended claims, and equivalents thereof.

What is claimed is:

1. A current-limiting circuit, which limits an electrical current from a voltage source to a consumer to a predetermined maximum current, comprising:
at least one measuring resistor connected into a current lead between a circuit input and a circuit output, and
at least two current control elements, each of which is connected in series to the at least one measuring resistor and each of which comprises a respective voltage-dependent control unit,
wherein each of the control units is connected to a respective voltage tap, which taps a voltage drop across the at least one measuring resistor.

2. The current-limiting circuit according to claim 1, wherein
the at least one measuring resistor comprises at least one of a wire-wound resistor and a metal-film resistor.

3. The current-limiting circuit according to claim 1, wherein:
at least one of the at least two current control elements comprises a transistor having a collector-emitter path, and
the transistor is coupled into the current lead with the collector-emitter path in series with the measuring resistor.

4. The current-limiting circuit according to claim 3, wherein
a base of the transistor is connected to the current lead through a series resistor and the respective control unit comprises a shunt regulator having a cathode connected to the base of the transistor and having an anode and a reference input connected to the voltage tap across the measuring resistor.

5. The current-limiting circuit according to claim 4, wherein
an additional current path is connected in parallel to the transistor and comprises a component that is connected reverse-biased and has a diode characteristic and an auxiliary measuring resistor that is integrated in the voltage tap.

6. The current-limiting circuit according to claim 5, wherein
an auxiliary series resistor is connected upstream to the component having the diode characteristic.

7. The current-limiting circuit according to claim 5, wherein
the component having the diode characteristic is a Z-diode.

8. The current-limiting circuit according to claim 5, wherein
the component having the diode characteristic is a further shunt regulator.

9. The current-limiting circuit according to claim 8, wherein:
the further shunt regulator comprises a cathode and a reference input, and
the reference input of the further shunt regulator is back-coupled to the cathode.
